(19) United States
(12) Patent Application Publication
(10) Pub. No.: US 2023/0090331 A1
(43) Pub. Date: Mar. 23, 2023

(54) LIGHTWEIGHT PLATE AND LIGHTWEIGHT PANEL INCLUDING LIGHTWEIGHT PLATE

(71) Applicant: MAXELL, LTD., Kyoto (JP)

(72) Inventors: Kei MIZUTANI, Kyoto (JP); Atsushi YUSA, Kyoto (JP)

(73) Assignee: MAXELL, LTD., Kyoto (JP)

(21) Appl. No.: 17/802,308

(22) PCT Filed: Mar. 8, 2021
(86) PCT No.: PCT/JP2021/008912

§ 371 Date: Aug. 25, 2022

(30) Foreign Application Priority Data
Mar. 13, 2020 (JP) 2020-043611

(51) Int. Cl. C08L 69/00

(52) U.S. Cl. CPC C08L 69/00

(57) ABSTRACT

A lightweight plate that contains polycarbonate resin and achieves good strength and formability while providing reduced weight, and a lightweight panel including such a lightweight plate. A lightweight plate includes a resin foam plate having an expansion ratio of 1.2 to 4, and a resin sheet containing fiber and overlaid on a major surface of the resin foam plate. The resin foam plate includes a polycarbonate resin in not less than 50 wt. %. The polycarbonate resin has a viscosity-average molecular weight of 10000 to 100000. The lightweight plate achieves reduced weight by having an expansion ratio of 1.2 to 4, and achieves good strength and formability by including a polycarbonate resin in not less than 50 wt.% and having a polycarbonate resin of a viscosity-average molecular weight of 10000 to 100000.

### TECHNICAL FIELD

The present disclosure relates to a lightweight plate and a lightweight panel including a lightweight plate.

### BACKGROUND ART

Generally, a plate of a metal such as iron or aluminum provides good strength, but has a relatively large weight. As such, using a plate made of metal. as an architectural material, for example, increases costs for transportation, installation and removal, for example, and/or physical burdens on workers. Plates with reduced weight have been proposed, as illustrated below.

JP 2018-141276 A discloses a lightweight stage plank panel. The stage plank panel includes two fiber-reinforced resin sheets and a hollow structure made of a polyolefin-based resin. The hollow structure is located between the two fiber-reinforced resin sheets and, like e.g. a honeycomb structure, defines a plurality of empty spaces separated by vertical walls and spaced apart from each other. The stage plank panel provides a predetermined strength by virtue of the hollow structure and two fiber-reinforced resin sheets.

2000-313023 A discloses a composite foam sheet mainly composed of a polyolefin-based resin and having high compression strength. The composite foam sheet includes a laminated foam sheet with a low-foamed sheet and a high-foamed sheet overlaid upon each other, and a sheet-shaped body overlaid on at least one side of the laminated foam sheet. The laminated foam sheet combines the low-foamed sheet, which provides high compression strength but is inferior in terms of lightweight properties, and the high-foamed sheet, which has low compression strength but is superior in lightweight properties. Thus, the composite foam sheet provides high compression strength and good lightweight properties.

### PRIOR ART DOCUMENTS

### Patent Documents

[Patent Document 1] JP 2018-141276 A

[Patent Document 2] JP 2000-313023 A

### SUMMARY OF THE INVENTION

However, the hollow structure of the stage plank panel has a relatively high proportion of empty spaces, and has decreased strength compared with a solid structure. Further, polyolefin-based resins have relatively low strength.

The composite foam sheet, which is mainly composed of a polyolefin-based resin, may have a strength suitable for use as the core of a composite building material for a tatami or floor; however, it still cannot be said to ensure a sufficient strength for applications that require higher strengths such as stage planks, discussed above.

Patent Document 2 discloses that the foam sheet is not limited to polyolefin-based resins and may be made of polycarbonate resin. Polycarbonate resins have higher strengths than polyolefin-based resins. However, polycarbonate resins are less foamable than other resins, and are not easy to mold.

In view of this, an object of the present disclosure is to provide a lightweight plate that contains polycarbonate resin and achieves good strength and formability while providing reduced weight, and a lightweight panel including such a lightweight plate.

To solve the above-identified problems, the present disclosure provides the following solutions: A lightweight plate according to the present disclosure may include: a resin foam plate having an expansion ratio of 1.2 to 4, i.e., capable of expanding by 1.2 to 4 times; and a resin sheet containing fiber and overlaid on a major surface of the resin foam plate. The resin foam plate may contain a polycarbonate resin in not less than 50 wt. %. The polycarbonate resin has a viscosity-average molecular weight of 10000 to 100000.

The lightweight plate and the lightweight panel according to the present disclosure contains polycarbonate resin and achieves good strength and formability while providing reduced weight.

### BRIEF DESCRIPTION OF THE DRAWINGS

FIG. 1 is an exterior perspective view of lightweight plate according to an embodiment, illustrating its structure.

FIG. 2 is an enlarged cross-sectional view of the lightweight plate shown in FIG. 1.

FIG. 3 is an exterior perspective view of a lightweight panel using the lightweight plate of FIG. 1, illustrating its structure.

### EMBODIMENTS FOR CARRYING OUT THE INVENTION

A lightweight plate may include; a resin foam plate having an expansion ratio of 1.2 to 4; and a resin sheet containing fiber and overlaid on a major surface of the resin foam plate. The resin foam plate may contain a polycarbonate resin in not less than 50 wt. %. The polycarbonate resin may have a viscosity-average molecular weight of 10000 to 100000. The lightweight plate achieves reduced weight by having an expansion ratio of 1.2 to 4. The lightweight plate achieves good strength and formability by containing a polycarbonate resin in not less than 50 wt. % and using a polycarbonate resin of a viscosity-average molecular weight of 10000 to 100000.

Preferably, the resin sheet may contain a polycarbonate resin in not less than 50 wt. % based on a resin contained in the resin sheet. Each of resins contained in the resin foam plate and the resin sheet may have a sea-island structure with the polycarbonate resin constituting a sea component. Thus, the non-polycarbonate resin contained together with the polycarbonate resin is positioned toward the interior of each of the resin foam plate and resin sheet to form an island component, while a significant amount of the polycarbonate resin constituting the sea component is exposed at the surface of a major surface of each of the resin foam plate and resin sheet. Thus, the adhesion between the resin foam plate and resin sheet can be improved by the compatibility between the polycarbonate resins. This will prevent the resin sheet from peeling away from the resin foam plate, further improving the strength of the lightweight plate.

Preferably, the resin foam plate may include a hole provided to reduce weight. Thus, the lightweight plate will have even better lightweight properties.

Preferably, in a vertical cross section of the resin foam plate, a proportion of a cross-sectional area of the hole based on an entire cross-sectional area of the resin foam plate may be 0.2 to 0.8. This enables striking a balance between keeping the strength of the lightweight plate and reducing its weight. If the proportion of the cross-sectional area of the hole is small, the strength of the lightweight plate can be maintained, but its weight cannot be reduced. On the other hand, if the proportion of the cross-sectional area of the hole is large, the weight of the lightweight plate can be reduced, but its strength may be insufficient. The above proportion reduces the weight of the lightweight plate and maintains its strength in a balanced manner.

Preferably, a resin sheet may be overlaid on each of two major surfaces of the resin foam plate. Thus, the lightweight plate will have improved bending strength against stresses applied to a major surface of the lightweight plate in the vertical direction.

Preferably, the resin foam plate may further include one selected from the group consisting of polypropylene resin, polyester resin, ABS resin, AS resin and acrylic resin.

Preferably, the resin foam plate may be foam-molded by a blowing agent. The blowing agent may contain a chemical blowing agent in 0 to 10 wt. % of the blowing agent. This will reduce the risk of a decrease in strength due to hydrolysis. Further, this will make it less likely to pollute the environment, and will reduce costs.

A lightweight panel may include: the above-described lightweight plate; and a frame positioned on a side of the lightweight plate. The frame may contain one selected from the group consisting of metal, carbon fiber, inactive particulate matter and fiber-reinforced resin. This will reinforce the lightweight plate.

Preferably, the lightweight panel may include two or more lightweight; plates arranged within the frame.

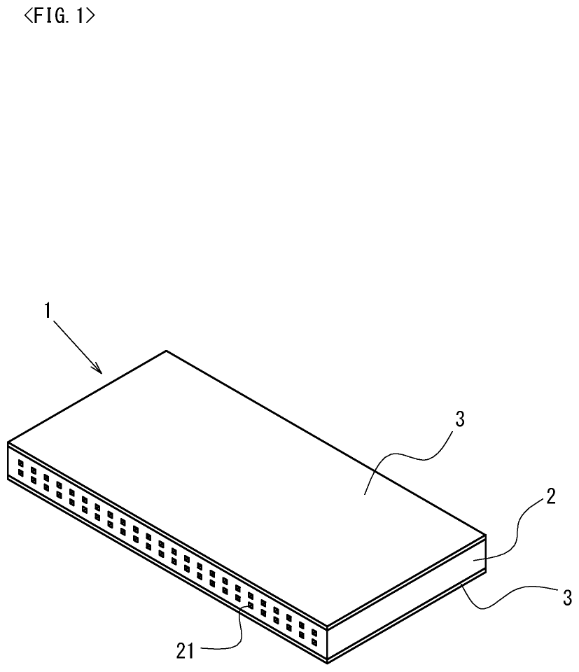

Now, embodiments of a lightweight plate 1 of the present disclosure will be specifically described with reference to FIGS. 1 to 3. First, as shown in FIG. 1, the lightweight plate 1 includes a resin foam plate 2 and resin sheets 3. The lightweight plate 1 may he used in applications that require strengths where metal plates are typically used, such as cores of building materials or structures of architectural or construction materials, for example.

The resin foam plate 2 contains polycarbonate resin in not less than 50 wt. %. The resin contained in the resin foam plate 2 may contain polycarbonate resin in 100 wt. %, or may be a compound of resin polycarbonate resin and at least one of another resin (hereinafter “non-PC resin”) and inactive particulate matter, or may be copolymer polycarbonate resin. Examples of non-PC resins include ABS resin, AS resin, acrylic resin, polyester resin (polyethylene terephthalate, polybutylene terephthalate, polyethylene naphthalate, polycyclohexane &methylene terephthalate and polybutylene naphthalate), PPS resin, polyphenylene ether resin, poly-ether sulfone resin, polysulfone resin, polypropylene resin, polyethylene resin, polystyrene resin, fluororesin (for example, polytetrafluoroethylene), polyamide resin, polyimide resin, cycloolefin resin, ethylene tetrafluoroethylene resin, polyvinylidene fluoride resin, polylactide resin, polybutylene succinate resin, polybutylene succinate adipate resin, the polycaprolactone resin, and hydroxybutyric acid-hydroxyhexanoic acid copolymer. One of the non-PC resins may be used alone, or two or more thereof may be used in combination. To improve the strength of the resin foam. plate 2, the amount of polycarbonate resin may be not less than 50 wt. %, preferably less than 60 wt. %, and more preferably not less than 70 wt. %. Examples of inactive particulate matters include talc, clay, silica, glass fiber, carbon fiber, cellulose, calcium carbonate and titanium oxide. One of the inactive particulate matters may be used alone, or two or more thereof may be used in combination. From the viewpoint of weight reduction, the amount of inactive particulate matter may be not more than 40 wt. %, preferably not more than 30 wt. %, and more preferably not more than 20 wt. %.

On the other hand, polycarbonate resin has high melt viscosity and low fluidity such that a physical blowing agent cannot easily be mixed therewith, making it difficult to ensure a high expansion ratio for the foam molding. Further, during physical foaming, polycarbonate resin is plasticized simply by addition of a blowing agent such that its melt viscosity tends to decrease; however, upon entry into the cooling process after foaming, viscosity rises. Thus, as discussed further below, when the polycarbonate resin is extruded from the die of the extruder for molding, air bubbles near the surface of the resin foam plate 2 may burst, thus roughening the surface. Thus, polycarbonate resin may suffer formability problems. These problems may be addressed by using a polycarbonate resin with low viscosity-average molecular weight (including a resin with a polycarbonate resin with high viscosity-average molecular weight blended with a polycarbonate resin with low viscosity-average molecular weight), or adding a resin with high fluidity or an additive such as filler to ensure a certain fluidity. However, using a polycarbonate resin with an excessively low viscosity-average molecular weight may decrease the strength of the resin foam plate 2. Thus, to maintain a balance between the strength and formability of the resin foam plate 2, the polycarbonate resin is to be alloyed with another, non-PC resin with good. fluidity. In view of all this, the amount of polycarbonate resin is preferably not more than 90 wt. %, and more preferably not more than 80 wt. %. The non-PC resin with good fluidity may be, in particular, at least one resin selected from the group consisting of a polyester resin (e.g., polyethylene terephthalate, polybutylene terephthalate, and polyethylene naphthalate), ABS resin, polypropylene resin and acrylic resin. Further, to improve strength, the content of the polycarbonate resin contained in the resin foam plate 2 may be 100 wt. %.

Further, the polycarbonate resin may be any resin that has a carbonate bond in the main chain; examples include aromatic polycarbonate, aliphatic polycarbonate, and aromatic-aliphatic polycarbonate. The polycarbonate resin is obtained, for example, by ester exchange between a dihydroxy compound and carbonic diester, or interfacial polycondensation of a dihydroxy compound and phosgene in the presence of an alkaline catalyst. The dihydroxy compound may be any compound having two hydroxy groups in the molecule; examples include aromatic dihydroxy compounds such as bisphenol A, 2,2-bis(3,5-dibromo-4-hydroxyphenyl)propane, 2,2-bis(4-hydroxyphenyl-3-methylphenyl)propane, 2,2-bis(3-tert-butyl-4-hydroxyphenyl)propane, 2,2-bis(3,5-dimethyl-4-hydroxyphenyl)propane, bis(4-hydroxyphenyl)methane, 1,1-bis(p-hydroxyphenyl)ethane, and 2,2-bis(p-hydroxyphenyl)butane; and aliphatic dihydroxy compounds such as ethylene glycol, 1,2-propylene glycol, 3-methyl-1, 5-pentanediol, 1,6-hexanediol, 1,3-propanediol, and 1,4-butanediol. One of these dihydroxy compounds may be used alone, or two or more or them may be used in combination. Other than a dihydroxy compound, the polycarbonate resin may contain a structural unit derived from a monohydroxy compound or a trihydroxy compound, for example.

In implementations where the resin foam plate 2 is formed by including polycarbonate resin and polypropylene resin, the polypropylene resin improves the foaming properties of the polycarbonate resin, i.e., improves fluidity to increase expansion ratio, thereby reducing the weight of the lightweight plate 1. Further, in implementations where the resin foam plate 2 is formed by including polycarbonate resin and ABS resin, expansion ratio can be increased as is the case with implementations where polypropylene resin is included, thereby reducing the weight of the lightweight plate 1. On the other hand, in implementations where the resin foam plate is formed by including polycarbonate resin and polyester resin, the polyester resin has a strength that is substantially equal to that of polycarbonate resin, and thus the lightweight plate 1 can maintain its strength. Thus, for the lightweight plate 1, a resin to be combined with polycarbonate resin can he decided upon depending on whether weight reduction or strength is more important. It is to be noted that, even when the weight is reduced, the resin foam plate 2 has sufficient strength since it contains polycarbonate resin in not less than 50 wt. %.

Further, the resin foam plate 2 is foam-molded. The resin foam plate 2 has an expansion ratio of 1.2 to 4. If the expansion ratio is low, the strength of the lightweight plate 1 increases but its effects in terms of heat resistance and lightweight properties decrease. On the other hand, if the expansion ratio is high, the strength of the resin foam plate 2 decreases but its heat resistance and lightweight properties improve. Thus, to strike a balance among the strength, heat resistance and lightweight properties of the lightweight plate 1, the expansion ratio is to be not lower than 1.2, preferably not lower than 1.4, and yet more preferably not lower than 1.6; the expansion ratio is to be not higher than 4, preferably not higher than 3, and yet more preferably not higher than 2.5.

The resin foam plate 2 is foam-molded by a blowing agent (i.e., at least one of a chemical blowing agent and a physical blowing agent). Examples of physical blowing agents include carbon dioxide gas, nitrogen, air, argon and helium. Further, the chemical blowing agent may be, for example, zinc carbonate, sodium bicarbonate and azodicarbonamide. Since the resin foam plate 2 is foam-molded using a chemical blowing agent, its expansion ratio tends to be high, thereby further reducing the specific weight of the resin foam plate 2. However, use of a chemical blowing agent also causes production of by-products such as water and/or ammonia, which reduces viscosity-average molecular weight and thus reduces the strength of the resin foam plate 2. In view of this, in foam molding with a chemical blowing agent, the viscosity-average molecular weight of the polycarbonate resin is to be not lower than 30000. Further, the resin foam plate 2, which is foam-molded using a physical blowing agent, not only provides a clean product that does not pollute the environment, but also is advantageous in terms of costs since atmospheric gases are used for air, nitrogen and carbon dioxide gas. In view of all this, in implementations where the resin foam plate 2 is foam-molded using a chemical blowing agent and a physical blowing agent in combination, the amount of chemical blowing agent is to be not more than 10 wt. % of the blowing agent. If foam molding is performed using a physical blowing agent and such a small amount of a chemical blowing agent compared with the physical blowing agent, this reduces the risk of a decrease in strength due to hydrolysis and also makes it less likely to pollute the environment, and also achieves a cost reduction. In other words, a balance is struck among costs, strength and lightweight properties.

The viscosity-average molecular weight of the polycarbonate resin is to be 10000 to 100000. If the viscosity-average molecular weight of the polycarbonate resin is too high, the viscosity increases and thus increases the torque required from the extruder, discussed below, making extrusion difficult. As a result, while polymerizing the resin improves the strength of the molding after processing, problems with manufacture itself occur. On the other hand, if the viscosity-average molecular weight of the polycarbonate resin is too low, bubbles can easily merge, which results in non-uniform bubble diameters, decreasing the strength after curing. Further, melt tension decreases, which makes foaming more difficult. In view of this, the viscosity-average molecular weight of the polycarbonate resin is to be not lower than 10000, preferably not lower than 12000, and more preferably not lower than 15000; the viscosity-average molecular weight is to be not higher than 100000, preferably not higher than 50000, and more preferably not higher than 30000. In other words, if the viscosity-average molecular weight of the polycarbonate resin is in the range of 10000 to 100000, this will produce the effects of improving the strength of the lightweight plate 1 and reducing its weight while allowing easy molding.

The viscosity-average molecular weight of the polycarbonate resin may also be a result of blending resins of molecular weights lower than 15000 or higher than 50000. For example, an aromatic polycarbonate resin with a viscosity-average molecular weight higher than 50000 has improved resin entropy elasticity and thus, during foam molding of the resin foam plate 2, exhibits good formability. Such improvements in formability are better than with branched polycarbonates. In even more suitable implementations, an aromatic polycarbonate resin may be used that is composed of an aromatic polycarbonate resin with a viscosity-average molecular weight of 70000 to 300000 and an aromatic polycarbonate resin with a viscosity-average molecular weight of 10000 to 30000, where the polycarbonate resin obtained by blending them or not blending them has a viscosity-average molecular weight of 16000 to 35000. Further, if the content of the non-PC resin that is contained. together with the polycarbonate resin is in 30 to 50 wt. % of the resin foam plate 2, a polycarbonate resin is suitably used that has a relatively high viscosity-average molecular weight of 25000 or higher.

In the present disclosure, viscosity-average molecular weight is calculated in the following manner: First, a solution of 0.7 g aromatic polycarbonate (i.e., resin contained in the resin foam plate 2) dissolved in 100 ml methylene chloride at 20° C. was prepared, and an Ostwald viscometer was used. to calculate specific viscosity (η_{SP}). Specific viscosity can be calculated by the expression {{t−t₀}/t₀}. t₀ is the number of seconds for which methylene chloride (i.e., solvent) falls, and t is the fall velocity of the specimen solution. The calculated specific viscosity is used to calculate viscosity-average molecular weight M by the expression {η_{SP}/c=[η]+0.45×[η]²c}. In the expression, [η] is the limiting viscosity {[η]=1.23×10⁻⁴M^{0.83}}. Further, in the expression, c is the concentration of aromatic polycarbonate (0.7%).

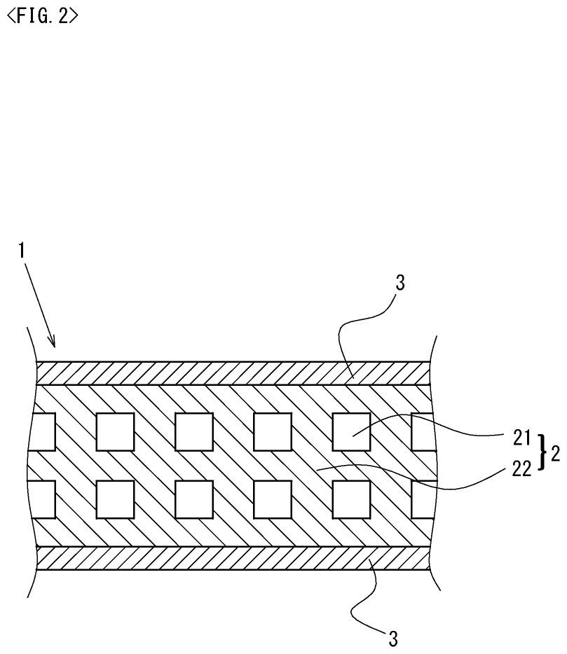

Further, the resin foam plate 2 includes two or more holes 21 provided to reduce weight. The two or more holes 21 are spaced apart from each other by a predetermined distance and extend in a direction parallel to the major surfaces of the resin foam plate 2. The holes 21 extend from one side of the resin foam plate 2 all the way to the other side opposite thereto to form openings in both sides. As shown in FIG. 2, the holes 21 have a generally rectangular cross-sectional shape. Providing these holes 21 further reduces the weight of the lightweight plate 1. In some implementations, the number of holes 21 is not limited to a plurality, and only one hole may be provided. In some implementations, holes 21 may extend in a direction perpendicular to the major surfaces of the resin foam plate 2. It is not necessary that the holes 21 be through-holes, which can easily be formed through extrusion; alternatively, they may be non-penetrating holes with openings in the surface of the resin foam plate 2, or may be empty spaces inside the resin foam plate 2. Further, the holes 21 are not limited to a generally rectangular cross-sectional shape, and may be circular, elliptical or polygonal in shape. Thus, various modifications can be made to the holes 21 in shape, size, or the positions at which they are provided, for example, as long as they achieve a reduction in the weight of the lightweight plate 1.

For example, holes 21 with a generally rectangular cross-sectional shape may be arranged in the width direction of the resin foam plate 2 such that the resin foam plate 2 forms a frame structure. Alternatively, holes 21 with a generally triangular cross-sectional shape and holes 21 with a generally inverted triangular cross-sectional shape may be alternately arranged in the width direction of the resin foam plate 2, or holes 21 with a generally triangular cross-sectional shape and holes 21 with a generally rectangular cross-sectional shape may be alternately arranged in the width direction of the resin foam plate 2 such that the resin foam plate 2 forms a truss structure. As used herein, generally triangular may mean the shape of a regular triangle or of an isosceles triangle, for example. Generally rectangular may mean the shape of a square, an oblong, a parallelogram or a trapezoid, for example. To improve the strength of the resin foam plate 2, the holes 21 of the resin foam plate 2 are suitably provided such that holes 21 with a generally triangular cross-sectional shape and holes 21 with a generally inverted triangular cross-sectional shape are alternately arranged in the width direction of the resin foam plate 2 and the cross-sectional shapes of the holes 21 arranged from the middle to left and right as determined along the width direction of the resin foam plate 2 are line-symmetrical with respect to the middle as determined along the width direction of the plate.

As shown in. FIG. 2, as viewed in a vertical cross section of the resin foam plate 2 perpendicular to the length direction of the two or more holes 21, the proportion of the cross-sectional areas of the holes 21 in the entire cross-sectional area of the resin foam plate 2 is 0.2 to 0.8. As used herein, entire cross-sectional area of the resin foam plate 2 means the sum of the cross-sectional areas of the plate portions 22 of the resin foam plate 2 and the cross-sectional areas of the holes 21 shown in FIG. 2. Further, the cross-sectional areas of the plate portions 22 include the cross-sectional areas of the bubbles in the resin foam plate 2 as foam-molded. If two or more holes 21 are provided, the cross-sectional area of the holes 21 is the total cross-sectional area of the holes 21. The proportion of the cross-sectional areas of the holes 21 can be calculated by the expression A/B, where A is the cross-sectional area of the holes 21, and B is the entire cross-sectional area of the resin foam plate 2. If the proportion of the cross-sectional area of the holes 21 is small, the strength of the lightweight plate 1 may be maintained but the weight cannot be reduced. On the other hand, if the proportion of the cross-sectional area of the holes 21 is large, the weight of the lightweight plate 1 may be reduced but the strength may be insufficient. In view of this, to strike a balance between reducing the weight of the lightweight plate 1 and maintaining its strength, the proportion of the cross-sectional area of the holes 21 is to be not lower than 0.2, preferably not lower than 0.3, and more preferably not lower than 0.4; the proportion is to be not higher than 0.8, preferably not higher than 0.7, and more preferably not higher than 0.6.

The resin sheets 3 are a fiber-reinforced resin sheets containing fiber, and overlaid on the respective major surfaces of the resin foam plate 2. That is, as shown in FIG. 1, the resin foam plate 2 is located between one resin sheet 3 and the other resin sheet 3. The resin sheets 3 are generally analogous in shape to the major surfaces of the resin foam plate 2. Thus, the lightweight plate 1 provides improved bending strength against stresses applied to a major surface of the lightweight plate 1 in the perpendicular direction. That is, the resin sheets 3 function as reinforcements of the resin foam plate 2. In some implementations, a single resin sheet 3 may be overlaid on one major surface of the resin foam plate 2.

Examples of resins forming the resin sheets 3 include polyester resin, epoxy resin, acrylic resin, polycarbonate resin, polyether sulfone resin, polyamide resin, polyethylene resin, polypropylene resin, polylactic resin, phenol resin, and polybutylene succinate resin. The resin contained in the resin sheets 3 is not limited to these examples, and other resin materials may be used.

The fiber contained in the resin sheets 3 is carbon fiber, glass fiber, aramnid fiber, polyester fiber, acrylic fiber, polyethylene fiber, polypropylene fiber, hollow metal fiber, or the like. Examples of hollow metal fibers include stainless steel and steel. The fiber contained in the resin sheets 3 is not limited to these examples, and other fiber materials may be used.

The weight per unit area of the fiber contained in the resin sheets 3 is 100 to 500 g/m². The fiber contained in the resin sheets 3 is at least one selected from the group including a cloth such as plain weave, twill weave, and. double cloth, a material. with fibers aligned. vertically, laterally and obliquely and fixed, and non-woven fabric, or a combination thereof overlaid. on each other. The fiber contained in the resin sheets 3 is preferably a cloth that is readily commercially available and can easily be treated. If the weight per unit area of the fiber is too low, the lightweight plate 1 is not sufficiently reinforced by the resin sheets 3, resulting in difficulty in ensuring the desired strength. On the other hand, if the weight per unit area of the fiber is too high, the weight of the lightweight plate 1 is relatively large, meaning difficulty in reducing weight. Further, a cloth heavier than 500 g/m² is difficult to cut and has too high a rigidity, potentially decreasing the workability during attachment. Thus, to strike an even better balance between improving strength and reducing weight, the weight per unit area of the fiber contained in the resin sheets 3 is to be not lower than 100 g/m², preferably not lower than 175 g/m², and more preferably not lower than 250 g/m²; the weight per unit area is to be not higher than 500 g/m², preferably not higher than 425 g/m², and more preferably not higher than 350 g/m².

In the resin foam plate 2, which contains 50 wt. % or more polycarbonate resin, the polycarbonate resin and the non-PC resin contained together with the polycarbonate resin form a sea-island structure. That is, the resin foam plate 2 forms a sea-island structure in which the polycarbonate resin constitutes the sea component and the non-PC resin contained together with the polycarbonate resin constitutes the island structure.

In this context, the resin sheets 3 may contain a polycarbonate resin in not less than 50 wt. % based on the resin contained in the resin sheets 3 (i.e., a compound resin having polycarbonate resin and at least one of a non-PC resin and inactive particulate matter, copolymer polycarbonate resin, or polycarbonate resin blended with a non-PC resin). In such implementations, the resin contained in the resin sheets 3 is the same as the resin contained in the resin foam plate 2 discussed above, and will not be described again. The resin sheets 3, too, which contain 50 wt. % or more polycarbonate resin, each form a sea-island structure in which the polycarbonate resin constitutes the sea component and the resin contained together with the polycarbonate resin constitutes the island component, as is the case with the foam plate 2.

Thus, the resin foam plate 2 and resin sheets 3, each containing polycarbonate resin in not less than 50 wt. %, each forms a sea-island structure in which the polycarbonate resin constitutes the sea component and the non-PC resin contained together with the polycarbonate resin constitutes the island component. That is, the non-PC resin contained together with the polycarbonate resin, which constitutes the island component, is located toward the interior of each of the resin foam plate 2 and resin sheets 3, and the major surfaces of each of the resin foam plate 2 and resin sheet 3 expose large amounts of the polycarbonate resin constituting the sea component. Thus, as discussed further below, during attachment of a resin sheet 3 to a major surface of the resin foam plate 2, the compatibility between the polycarbonate resins improves the attachment adhesion between the resin foam plate 2 and resin sheet 3. This will prevent the resin sheet 3 from peeing away from the resin foam plate 2, thereby further improving the strength of the lightweight plate 1. Again, the amount of the polycarbonate resin contained in each of the resin foam plate 2 and resin sheet 3 is to be not smaller than 50 wt. %, preferably not smaller than 60 wt. %, and more preferably not smaller than 70 wt. %.

It is to be noted that polycarbonate resin, with increasing load applied thereto, yields and plastically deforms and then breaks, but exhibits a large amount of plastic deformation from yield to break. Thus, polycarbonate resin does not break immediately after it yields, that is, is tough in nature. As such, when a deformation of the lightweight plate 1 is observed, there is a certain time available for one to devise a way to address the risk of a subsequent break of the lightweight plate 1.

### Method of Manufacturing Lightweight Plate 1

Next, a method of manufacturing the lightweight plate 1 will be specifically described.

A resin foam plate 2 is formed by profile extrusion. Specifically, first, an extruder such as a screw is loaded with pellets of polycarbonate resin and pellets of a non-PC resin, such as polypropylene resin, which are heated and melted and blended such that polycarbonate resin accounts for 50 wt. % or more, thereby producing a molten resin material. The proportion of 50 wt. % or more of polycarbonate resin (i.e., pellets) is a proportion based on the weight including the weights of the non-PC resin (i.e., pellets) and inactive particles, for example, loaded into the extruder. Further, within the extruder, at least one of a chemical blowing agent and a physical blowing agent is injected into the molten resin material, and the molten resin material and blowing agent are blended.

Subsequently, the molten resin material blended with the blowing agent is poured into a die and allowed to pass through the die to let the temperatures gradually decrease, thereby molding the resin foam plate 2 to a predetermined shape. The die has an opening through which the molten resin material including the blowing agent ed therewith is extruded. One or more partitions are disposed in the plane of the opening of the die for forming the two or more holes 21. Thus, two or more generally parallel holes 21 extending in the direction of extrusion are formed in the resin foam plate 2. At the same time, as the molten resin material blended with the blowing agent passes through the die, its pressures decrease, which produces bubbles. In this manner, the resin foam plate 2 is foam-molded. It is to be noted that the molten resin material flows in while being compressed by the plurality of partitions. This increases the density of resin located between adjacent ones of the two or more holes, which is presumed to prevent a decrease in strength despite the fact that two or more holes 21 are formed.

Next, a resin sheet 3 is attached to a major surface of the resin foam plate 2. That is, a resin sheet 3 is attached, without an adhesive, to a major surface of the resin foam plate 2 prior to curing due to cooling. As discussed above, the resin sheet 3 is formed by immersing a woven fiber material such as plain weave in resin. The production of the resin sheet 3 is not limited to any particular method.

Next, the molded resin foam plate 2 and resin sheet 3 are cooled in a cooling pool to adjust its shape. In this state, the resin foam plate 2 and resin sheet 3 have the shape of a continuous sheet. The resin foam plate 2 and resin sheet 3 having the shape of a continuous sheet is cut into a predetermined size. This results in the resin foam plate 1.

Another method of attaching a resin sheet 3 to the resin foam plate 2 may involve cooling the resin foam plate 2 for curing and, then, applying an appropriate amount of a solvent capable of dissolving polycarbonate resin, for example, to a surface of one of the resin foam plate 2 or resin sheet 3 or to those surfaces thereof that face each other, before attaching them together and drying them.

Although the above-described manufacturing method involves cutting the resin foam plate 2 and resin sheet 3 at the same time, a continuous sheet for resin foam plates 2 may be cut before a resin sheet 3 is overlaid on each of them.

Further, the method of molding the resin foam plate 2 is not limited to profile extrusion, and may be another molding method, such as injection molding. Further, the method of foam-molding the resin foam plate 2 may be modified as appropriate depending on the method of molding the resin foam plate 2. For example, if a polycarbonate resin with a viscosity-average molecular weight not lower than 30000 is to be molded, the following method may be adopted: First, polycarbonate resin is dissolved in an organic solvent (e.g., methylene chloride) to prepare dope (with a solid-component concentration of 50% or higher). Next, under a temperature lower than the volatilization temperature of the organic solvent, a blowing agent is mixed with that dope and stirred to prepare bubble-containing dope. Thereafter, this bubble-containing dope is poured into a mold and heated slowly at a temperature near the volatility temperature of the organic solvent. The heating causes the organic solvent to volatilize from the bubble-containing dope to cure the bubble-containing dope; removal from the mold results in the resin foam plate 2. If the holes 21 are to be formed by this method, support poles may be provided in the interior space of the mold into which the bubble-containing dope is poured. For example, in implementations where holes 21 with a triangular cross-sectional shape are to be formed, support poles that each take the shape of a triangular prism are attached to the mold in its interior space before the bubble-containing dope is poured into the mold. Then, curing of the bubble-containing dope and removal from the mold result in holes 21 with a triangular cross-sectional shape at the positions corresponding to the positions of the support poles.

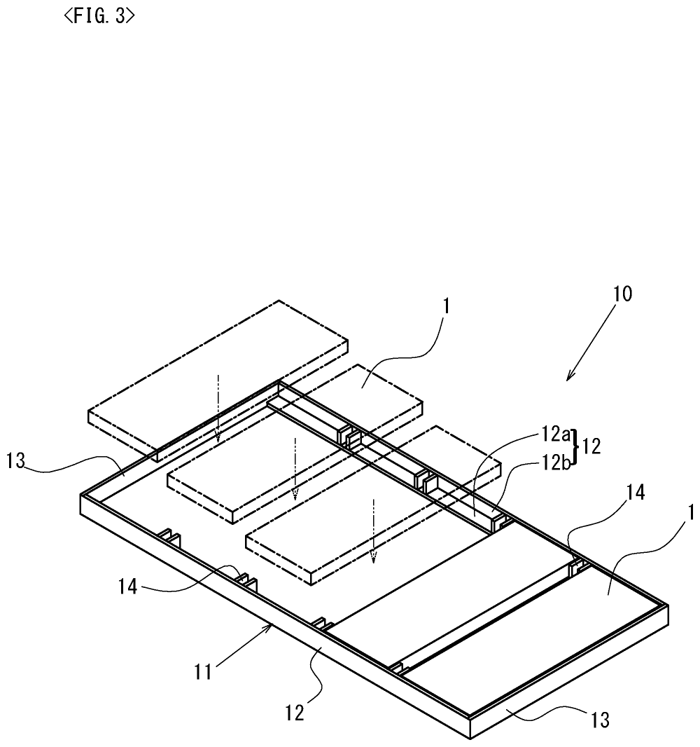

Now, a lightweight panel 10 using the lightweight plate 1 of the present disclosure will be specifically described with reference to FIG. 3. As shown in FIG. 3, the lightweight panel 10 includes lightweight plates 1 as described above and a frame 11.

The frame 11 is generally rectangular in shape in plan view. The frame 11 includes a pair of frame members 12 that face each other, and a pair of frame members 13 that face each other. Each of the frame members 12 includes a flange 12a and a wall 12b extending from an edge of the flange 12a in a direction perpendicular thereto, and thus has a generally L-shaped cross section. Each of the frame members 12 is positioned such that the flange 12a is located inward of the wall 12b. Each of the frame members 13 takes the shape of a flat plate. A plurality of partitions 14 are provided on the upper surface of the flange 12a of one frame member 12. Partitions 14 are provided on the upper surface of the flange 12a of the other frame member 12 to be positioned to face the partitions 14 on the flange 12a of the one frame member 12.

The frame 11 contains one selected from the group consisting of metal, carbon fiber, inactive particulate matter and fiber-reinforced resin. The frame 11 may contain one of these materials, or two or more thereof.

Each lightweight plate 1 is fitted into the area defined by the walls 121), partitions 14 and the flanges 12a. As shown in FIG. 3, each of the lightweight plates 1, except for the lightweight plates 1 adjacent to the frame members 13, is fixed in position by partitions 14 located at the four corners of the lightweight plate 1. In other words, between a lightweight plate 1 and an adjacent lightweight plate 1 are provided two partitions 14 for each frame member 12. The lightweight plate 1 adjacent to a frame member 13 is fitted into the area defined by the frame member 13, partitions 14, the flanges 12a and the walls 12b. An end of a lightweight plate 1 that faces a frame member 12 is supported by the associated flange 12a. Thus, a plurality of lightweight plates 1 are provided inside a single frame 11 and attached thereto.

Thus providing the frame 11 along the sides of a lightweight plate 1 reinforces the lightweight plate 1, and also allows a plurality of lightweight plates 1 to be positioned. Thus, for example, when a load is supported on the upper surface of the lightweight panel 10 and if one lightweight plate 1 breaks, the load can be supported by the two lightweight plates 1 adjacent to the broken lightweight plate 1. Further, partitions 14 that are present between one lightweight plate 1 and another lightweight plate 1 adjacent to that one lightweight plate 1 create a clearance. Thus, the lightweight panel 10 achieves reduced weight. Further, for some locations where the lightweight panel 10 is installed, this can provide for improvements in air permeability.

One lightweight plate 1 may be provided inside the frame 11, or a plurality of plates may he provided. Further, the frame members 13 may also have a generally L-shaped cross section, similar to the frame members 12. Furthermore, regarding the partitions 14, only one partition 14 may be provided between adjacent lightweight plates 1 for each frame member 12. The partitions 14 are not limited to the above-described construction as long as they separate adjacent lightweight plates 1 and enable easy positioning of the lightweight plates 1 during fitting thereof. Further, regarding the partitions 14, one or more partitions 14 may be provided for each frame member 12 depending on, for example, the number of lightweight plates 1 provided inside the frame 11. Moreover, the lightweight plates 1 may be attached to the frame 11 without using partitions 14 provided inside the frame.

Although embodiments have been described, the present disclosure is not limited to the above-described embodiments, and various modifications are possible without departing from the spirit of the disclosure.

### EXAMPLES

As shown in Table 1 provided below, lightweight plates for Inventive Examples 1 to 6 and lightweight plates for Comparative Examples 1 to 5 were fabricated, and each lightweight plate was tested to evaluate load resistance as well as the adhesion between a resin foam plate and resin sheets.

Specifically, the testing method involved: preparing a resin foam plate (200 mm wide, 500 mm long, and 28 mm thick); overlaying a resin sheet (200 mm wide, 500 mm long, and 1 mm thick) on each of the major surfaces of the resin foam plate to prepare a lightweight plate; and evaluating the load resistance of, and adhesion within, the lightweight plate by the following methods.

Load resistance was evaluated by letting the lightweight plate be supported on concrete blocks with a height of 300 mm, each block covering the entire lower surface within a range of 50 mm from the associated one of the plate's ends as determined along its length direction toward the middle along the length direction; placing a columnar plumb bob (with a diameter of 150 mm, a height of 495 mm, and a weight of 100 kg) on the center of the upper surface of the lightweight plate; and observing the changes in the lightweight plate. More specifically, for evaluation, a lightweight plate was classified as “A” if it did not break and had an amount of bend smaller than 1 cm after a repetition, 50 times or more, of a procedure including placing a plumb bob on the upper surface of the lightweight plate for one minute and then leaving the plate without the bob thereon for one minute; a lightweight plate was classified as “B” if it did not break and had an amount of bend smaller than 1 cm after a plum bob had been placed on the upper surface of the lightweight plate; a lightweight plate was classified as “C” if it did not break but had an amount of bend not smaller than 1 cm after a plumb bob had been placed on the upper surface of the lightweight plate; and a lightweight plate was classified as “D” if it broke when a plumb bob had been placed on the upper surface of the lightweight plate.

For evaluation of the adhesion of a resin sheet, a resin sheet was classified as “A” if it did not peel away from the lightweight plate after a repetition, 50 times or more, of a procedure including placing a plumb bob on the upper surface of the lightweight plate for one minute and then leaving the plate without the bob thereon for one minute; a resin sheet; was classified as “B” if it did not peel away from the lightweight plate after a plumb bob had been placed on the upper surface of the lightweight plate; a resin sheet was classified as “C” if it peeled off in an area smaller than 10% of the entire resin sheet after a plumb bob had been placed on the upper surface of the lightweight plate; and a resin sheet was classified as “D” if it peeled off in an area of 10% or larger of the entire resin sheet after a plumb bob had been placed on the upper surface of the lightweight plate. The fiber material used for the resin sheets was aramid fiber or carbon fiber; using one or the other did not significantly affect the test results.

The test results are shown in Table 1 provided below. “PC” in Table 1 means polycarbonate. “PET” means polyethylene terephthalate. “PP” means polypropylene. “PMMA” means methacrylic resin. Viscosity-average molecular weight and the proportion of holes in cross section (i.e., total proportion of the cross sections of the holes) were calculated by the above-described methods.

TABLE 1

| | Resin Foam Plate | | | | | | | | | | |
|---|---|---|---|---|---|---|---|---|---|---|---|
| | | | | | Proportion | | Amount of | Resin Sheet | | | |
| | | Proportion | Expansion | PC resin | of holes | | blowing | | Proportion | | |
| | | of PC resin | ratio | molecular | in cross | Blowing | agent | | of PC resin | Load | |
| | Resin | (wt. %) | (times) | weight | section | agent | added (%) | Resin | (wt. %) | Resistance | Adhesion |
| Inv. | PC/PET | 60 | 1.6 | 15000 | 0.8 | CO₂ | 1 | PC/ABS | 60 | B | B |
| Ex. 1 | | | | | | | | | | | |
| Inv. | PC/PP | 80 | 2.5 | 18000 | 0.4 | CO₂ | 1 | PC/PP | 70 | B | A |
| Ex. 2 | | | | | | | | | | | |
| Inv. | PC | 100 | 1.5 | 30000 | 0.7 | CO₂ | 1 | PC | 100 | A | A |
| Ex. 3 | | | | | | | | | | | |
| Inv. | PC/PET | 50 | 3 | 30000 | 0.4 | CO₂/ADCA | 0.95/0.05 | PC/PET | 50 | A | B |
| Ex. 4 | | | | | | | | | | | |
| Inv. | PC/PET | 80 | 1.8 | 10500 | 0.8 | CO₂/ADCA | 0.95/0.05 | PC/PET | 30 | C | B |
| Ex. 5 | | | | | | | | | | | |
| Inv. | PC | 100 | 1.7 | 25000 | 0.5 | CO₂ | 1 | PC/PP | [symbol] 0 | B | C |
| Ex. 6 | | | | | | | | | | | |
| Comp. | PC/PET | 30 | 5 | 9000 | 0.9 | CO₂ | 1 | PC/PP | 30 | D | D |
| Ex. 1 | | | | | | | | | | | |
| Comp. | PC/PMMA | 60 | 18 | 15000 | 0. [symbol] | CO₂ | 1 | PC/PP | 40 | D | C |
| Ex. 2 | | | | | | | | | | | |
| Comp. | PC/PET | 45 | 1.5 | 9000 | 0.5 | ADCA | 1 | PC/PP | 30 | D | D |
| Ex. 3 | | | | | | | | | | | |
| Comp. | PC | 100 | 1.5 | 8500 | 0.7 | CO₂ | 1 | PC | 100 | D | B |
| Ex. 4 | | | | | | | | | | | |
| Comp. | PC/ABS | 20 | 5 | 30000 | 0.7 | CO₂ | 1 | PC/PET | 20 | C | D |
| Ex. 5 | | | | | | | | | | | |

[symbol]

indicates data missing or illegible when filed

For the lightweight plate for Inventive Example 1, the proportion of polycarbonate resin in the resin foam plate was 60 wt. %, where a polycarbonate resin with a viscosity-average molecular weight of 15000 was used to make it relatively easy to form compared with the lightweight plates for the other inventive examples, and it achieved a load resistance of “B”, which is relatively good. Further, as the proportion of polycarbonate resin contained in each resin sheet was 60 wt. %, a sea-island structure with polycarbonate resin constituting the sea component was formed, and the compatibility with the polycarbonate resin in the resin foam plate provided an adhesion of “B”, which is relatively good.

The lightweight plate for Inventive Example 2 had a higher proportion of polycarbonate resin contained in each of the resin foam plate and resin sheet than the lightweight plate for Inventive Example 1. Regarding evaluation of load resistance, it was classified as “B”, as was the case with Inventive Example 1. However, it is believed that, in reality, the lightweight plate for Inventive Example 2 had improved strength than Inventive Example 1, even though the resin foam plate for Inventive Example 2 had a lower formability. Further, regarding evaluation of adhesion, it was classified as “A” due to its improved compatibility.

In the lightweight plate for Inventive Example 3, the resin foam plate was formed from 100 wt. % of a polycarbonate resin (with a viscosity-average molecular weight of 30000); thus, it achieved a load resistance of “A”, although the formability of the resin foam plate was lower than those for the resin foam plates for Inventive Examples 1 and 2. However, a polycarbonate resin with a viscosity-average molecular weight of 30000 usually ensures sufficient formability compared with polycarbonate resins with viscosity-average molecular weights exceeding 50000 (especially 100000). Further, since the resin sheet 3 was formed from 100 wt. % polycarbonate resin, it had improved compatibility with the resin foam plate, and achieved an adhesion of “A”, as was the case with the lightweight plate for Inventive Example 2.

In the lightweight plate for Inventive Example 4, the proportion of polycarbonate resin in the resin foam plate was 50 wt. %, which is substantially the same as for Inventive Example 1, but achieved a load resistance of “A”, as was the case with the lightweight plate for Inventive Example 3. This is presumably because Inventive Example 4 used a polycarbonate resin with a viscosity-average molecular weight of 30000, which is higher than that of Inventive Example 1, to form the resin foam plate. As such, the resin foam plate for Inventive Example 4 had improved strength, although it had a lower formability than the resin foam plate for Inventive Example 1. Regarding evaluation of adhesion, the lightweight plate for Inventive Example 4 was classified as “B”, somewhat inferior to the lightweight plates for Inventive Examples 2 and 3.

In the lightweight plate for Inventive Example 5, the proportion of polycarbonate resin contained in the resin foam plate was 80 wt. %; however, the viscosity-average molecular weight of the polycarbonate resin was 10500, which is lower than those of the lightweight plates for the other inventive examples. Thus, the formability of the resin foam plate is believed to have been better than those of the other inventive examples, but the load resistance was “C”. Further, the adhesion was “B”, as was the case with Inventive Example 1.

In the lightweight plate for Inventive Example 6, the proportion of polycarbonate resin contained in the resin foam plate was 100 wt. %, but had a somewhat lower load resistance than the lightweight plate for Inventive Example 3. This is presumably because of the larger proportion of holes in cross section.

In the lightweight plate for Comparative Example 1, the proportion of polycarbonate resin in the resin foam plate was 30 wt. %, which is relatively low; the expansion ratio was 5, which is relatively high; the viscosity-average molecular weight of the polycarbonate resin was 9000, which is relatively low; and the proportion of holes in cross section was 0.9, which is relatively high. Consequently, the load resistance was “D”, which demonstrates that it easily broke. Further, the proportion of polycarbonate resin in the resin sheet was 30 wt. %, which is low, and the compatibility with the polycarbonate resin in the resin foam plate was low, which shows that adhesion was not achieved, either.

The lightweight plate for Comparative Example 2 had an expansion ratio of 13, which is high. Thus, the load resistance was “D”. Further, while the proportion of polycarbonate resin in the resin foam plate was 60 wt. %, the proportion of polycarbonate resin of the resin sheet was 40 wt. %, which is relatively low. As such, the adhesion was “C”.

In the lightweight plate for Comparative Example 3, although the proportion of polycarbonate in the resin foam plate was relatively low and the viscosity-average molecular weight of the polycarbonate resin was also relatively low, the expansion ratio was in a good range. Nevertheless, the lightweight plate for Comparative Example 3 had a load resistance of “D”. This is presumably because the blowing agent used was ADCA, which is a chemical blowing agent. This suggests that the blowing agent used to foam-mold the resin foam plate is suitably in the amount of 1 wt. % relative to the total amount of the resin and additives contained in the resin foam plate and, if the blowing agent contains any chemical blowing agent, its amount is suitably not higher than 0.1 wt. % of the blowing agent, as in Inventive Examples 4 and 5.

For the lightweight plate for Comparative Example 4, the viscosity-average molecular weight of the resin foam plate was extremely low, and thus failed to provide strength. Still, since the proportion of polycarbonate resin in each of the resin foam plate and resin sheet was 100 wt. %, adhesion was achieved.

In the lightweight plate for Comparative Example 5, the viscosity-average molecular weight of the polycarbonate resin in the resin foam plate was relatively high and, as a result, the load resistance was “C”; there was no compatibility between the resin of the resin foam plate and the resin of the resin sheet and, as a result, the adhesion was “D”. It is to he noted that, although the load resistance of the lightweight plate for Comparative Example 5 was “C”, as was the case with Inventive Example 5, the proportion of polycarbonate resin in the resin foam plate was lower than that for Inventive Example 5 and the expansion ratio was higher than that for Inventive Example 5. This suggests that the lightweight plate for Comparative Example 5 had a lower strength than the that for Inventive Example 5.

These results suggest that, to provide a certain strength of a lightweight plate and a certain formability of the resin foam plate while reducing the weight of the lightweight plate, there is a tendency that good results can be obtained by striking a balance among the proportion of polycarbonate resin in the resin foam plate, the expansion ratio of the resin foam. plate, and the viscosity-average molecular weight of the polycarbonate resin in the resin foam plate, where the proportion of polycarbonate is not lower than 50 wt. %, the expansion ratio is in the range of 1.2 to 4, and the viscosity-average molecular weight is in the range of 10000 to 100000. Particularly, the results demonstrate a tendency that even better load resistance can be obtained by having the proportion of polycarbonate resin in the resin foam plate in the range of 80 wt. % or above, the expansion ratio in the range of 1.6 to 3, and the viscosity-average molecular weight of the polycarbonate resin in the resin foam plate in the range of 15000 to 30000.

Further, regarding the adhesion within the lightweight plate, the results demonstrate that there is a tendency that good adhesion is achieved if the proportion of polycarbonate resin contained in each of the resin foam plate and the resin contained in the resin sheet is not lower than 50 wt. %. Further, the results demonstrate that even better adhesion is achieved if the proportion of polycarbonate resin contained in each of the resin foam plate and the resin contained in the resin sheet is not lower than 70 wt. % or not lower than 80 wt. %.

To discuss the proportion of holes in cross section, the lightweight plates for Inventive Examples 1 to 6 demonstrate that good load resistance is achieved if the proportion of holes in cross section is in the range of 0.3 to 0.8 even if various parameters such as the proportion of polycarbonate resin are modified. Further, for Inventive Example 5, where the viscosity-average molecular weight of polycarbonate resin was 10500, which is slightly higher than the above-mentioned lower limit of 10000, and the proportion of holes in cross section was 0.8, the load resistance was “C”. This suggests that the proportion of holes in cross section is suitably not higher than 0.8. Further, for Comparative Example 1, where the proportion of holes in cross section was 0.9, the load resistance was “D”, although this may have been caused by other factors. On the other hand, the results demonstrate that there is a tendency that having a proportion of holes in cross section of about 0.5 gives better load resistance. It is to be noted that implementations without holes provide better strength than implementations with holes.

### REFERENCE SIGNS LIST

1: lightweight plate

2: resin foam plate

21: holes

22: plate portions

3: resin sheets

10: lightweight panel

11: frame

12: frame members

12a: flanges

12b: walls

13: frame members

14: partitions

1. A lightweight plate comprising:
a resin foam plate having an expansion ratio of 1.2 to 4; and
a resin sheet containing fiber and overlaid on a major surface of the resin foam plate,
wherein the resin foam plate contains a polycarbonate resin in not less than 50 wt. %, and
the polycarbonate resin has a viscosity-average molecular weight of 10000 to 100000.

2. The lightweight plate according to claim 1, wherein:
the resin sheet contains a polycarbonate resin in not less than 50 wt. % based on a resin contained in the resin sheet; and
each of resins contained in the resin foam plate and the resin sheet has a sea-island structure with the polycarbonate resin constituting a sea component.

3. The lightweight plate according to claim 1, wherein the resin foam plate includes a hole provided to reduce weight.

4. The lightweight plate according to claim 3, wherein, in a vertical cross section of the resin foam plate, a proportion of a cross-sectional area of the hole based on an entire cross-sectional area of the resin foam plate is 0.2 to 0.8.

5. The lightweight plate according to claim 1, wherein a resin sheet is overlaid on each of two major surfaces of the resin foam plate.

6. The lightweight plate according to claim 1, wherein the resin foam plate further includes one selected from the group consisting of polypropylene resin, polyester resin, ABS resin, AS resin and acrylic resin.

7. The lightweight plate according to claim 1, wherein:
the resin foam plate is foam-molded by a blowing agent; and
the blowing agent contains a chemical blowing agent in 0 to 10 wt. % based on the blowing agent.

8. A lightweight panel comprising:
the lightweight plate according to claim 1; and
a frame positioned on a side of the lightweight plate,
wherein the frame contains at least one selected from the group consisting of metal, carbon fiber, inactive particulate matter and fiber-reinforced resin.

9. The lightweight panel according to claim 8, wherein the lightweight panel includes two or more lightweight plates arranged within the frame.
